(19) United States
(12) Patent Application Publication
(10) Pub. No.: US 2016/0288559 A1
(43) Pub. Date: Oct. 6, 2016

(54) PRINTABLE RECORDING MEDIA

(71) Applicant: Hewlett-Packard Development Company, L.P., Houston, TX (US)

(72) Inventors: Tao CHEN, San Diego, CA (US); Xi ZENG, San Diego, CA (US); Christopher Arend TOLES, Escondido, CA (US)

(21) Appl. No.: 15/038,663

(22) PCT Filed: Dec. 13, 2013
(86) PCT No.: PCT/US2013/074991

§ 371 Date: May 23, 2016

(51) Int. Cl. B41M 5/52

(52) U.S. Cl. CPC B41M 5/5218; B41M 5/5254

(57) ABSTRACT

A printable recording media containing and a coating layer including an acrylic resin latex binder; and a mixture of: about 10 to about 90 wt % of a first pigment including precipitated calcium carbonate particles, about 5 to about 60 wt % of a second pigment having a larger size and a different shape than the first pigment particles, and about 1 to about 50 wt % of a third pigment having a surface area of at least 50 m²/gram, wherein the weight percentages are by combined weight of the first, second and third pigments by total dry weight of the coating layer. Also described herein are a method for making said printable recording media and a method for producing printed images using the recording media.

### BACKGROUND

Inkjet printing is a non-impact printing method in which an electronic signal controls and directs droplets or a stream of ink that can be deposited on a variety of substrates. Current inkjet printing technology involves forcing the ink drops through small nozzles by thermal ejection, piezoelectric pressure or oscillation, onto the surface of a media. This technology has become a popular way of recording images on various media surfaces, particularly paper, for a number of reasons, including low printer noise, capability of high-speed recording and multi-color recording. Inkjet web printing is a technology that is specifically well adapted for commercial and industrial printing.

It has rapidly become apparent that the image quality of printed images using such printing technology is strongly dependent on the construction of the recording media used. Consequently, improved recording media, often specifically designed, have been developed. However, while many developments have been made, it has often created challenges to find effective printable recording media. Accordingly, investigations continue into developing such media substrates.

### BRIEF DESCRIPTION OF THE DRAWINGS

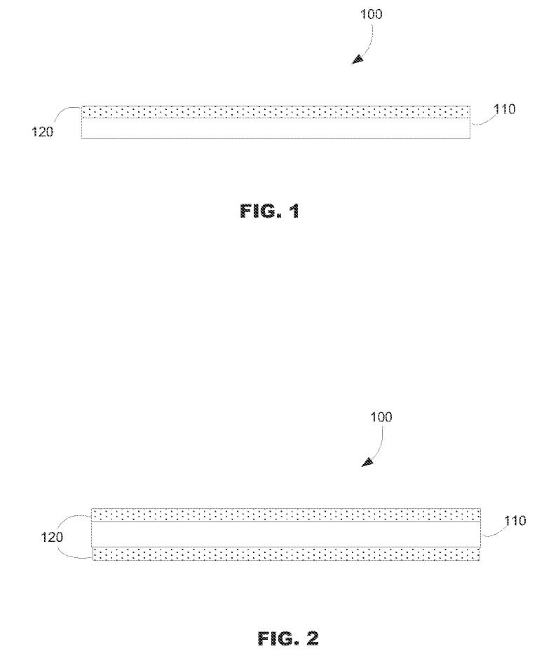

The drawings illustrate various embodiments of the present recording media and are part of the specification. FIGS. 1 and 2 are cross-sectional views of the printable recording media according to embodiments of the present disclosure.

### DETAILED DESCRIPTION

Before particular embodiments of the present disclosure are disclosed and described, it is to be understood that the present disclosure is not limited to the particular process and materials disclosed herein. It is also to be understood that the terminology used herein is used for describing particular embodiments only and is not intended to be limiting, as the scope of protection will be defined by the claims and equivalents thereof. In describing and claiming the present media and method, the following terminology will be used: the singular forms “a”, “an”, and “the” include plural referents unless the context clearly dictates otherwise. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For examples, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. All percent are by weight (wt %) unless otherwise indicated. “Dry weight” refers herein to the weight of a component when the liquid it is suspended or dissolved into has been removed. As used herein, “image” refers to marks, signs, symbols, figures, indications, and/or appearances deposited upon a material or substrate with either visible or an invisible ink composition. Examples of an image can include characters, words, numbers, alphanumeric symbols, punctuation, text, lines, underlines, highlights, and the like.

The present disclosure refers to printable recording media containing a base substrate and a coating layer including an acrylic resin latex binder; and a mixture of: about 10 to about 90 wt % of a first pigment including precipitated calcium carbonate particles, about 5 to about 60 wt % of a second pigment having a larger size and a different shape than the first pigment particles, and about 1 to about 50 wt % of a third pigment having a surface area of at least 50 m²/gram, wherein the weight percentages are by combined weight of the first, second and third pigments by total dry weight of the coating layer. The present disclosure refers also to a method for producing printed images using the recording media.

The printable recording media, described herein, provides printed images that demonstrate excellent image quality (good bleed and coalescence performance) and enhance durability performance while enabling high-speed and very high-speed printing. By high-speed printing, it is meant herein that the printing method can be done at a speed of 50 fpm or higher. As durability performance, it is meant herein that the resulting printed images are robust to dry and wet rubbing that can be done by going through finishing equipment (slitting, sheeting, folding, etc.) or by the user.

The printable recording media according to the present disclosure provides printed images that have outstanding print durability and excellent scratch resistance while maintaining good jettability. By scratch resistance, it is meant herein that the composition is resistant to all modes of scratching which include, scuff, abrasion and burnishing. By the term “scuff”, it is meant herein all damages to a print due to dragging something blunt across it (like brushing fingertips along printed image). Scuffs do not usually remove colorant but they do tend to change the gloss of the area that was scuffed. By the term “abrasion”, it is meant herein the damage to a print due to wearing, grinding or rubbing away due to friction. Abrasion is correlated with removal of colorant (i.e. with the OD loss). An extreme abrasive failure would remove so much colorant that the underlying white of the paper would be revealed. The term “burnishing” refers herein to changing the gloss via rubbing. A burnishing failure appears as an area of differential gloss in a print.

In some examples, the printable recording media described herein is a coated media that can be printed at speeds needed for commercial and other printers such as, for example, a Hewlett Packard (HP) Inkjet Web Press (Hewlett Packard Inc., Palo Alto, Calif., USA). The properties of such printable recording media are comparable to coated media for offset printing.

In addition, the printable media has a fast absorption rate. By “fast absorption rate”, it is meant that the water, solvent and/or vehicle of the ink can be absorbed by the media at a fast rate so that the ink composition does not have a chance to interact and cause bleed and/or coalescence issues. The faster the printing speed and the higher the amount of ink used, the higher is the demand on faster absorption from the media. A good diagnostic plot with maximum ink density, especially secondary colors, would be prone to coalescence and a pattern of lines of all primary and secondary colors passing through area fills of primary and secondary colors would be prone to bleed. If no bleed or coalescence is present at the desired printing speed, the absorption rate would be sufficient. Bristow wheel measurements can be used for a quantitative measure of absorption on media wherein a fixed amount of a fluid is applied through a slit to a strip of media that moves at varying speeds.

FIG. 1 and FIG. 2 illustrate the printable recording media (100) as described herein. As illustrated in FIG. 1, the printable media (100) encompasses a bottom supporting substrate (110) and a coating layer (120). The coating layer (120) is applied on one side of the bottom supporting substrate (110). If the coated side is used as an image-receiving side, the other side, i.e. backside, may not have any coating at all, or may be coated with other chemicals (e.g. sizing agents) or coatings to meet certain features such as to balance the curl of the final product or to improve sheet feeding in printer. In some examples, such as illustrated in FIG. 2, the coating layer (120) is applied to both opposing sides of the supporting substrate (110). The double-side coated media has thus a sandwich structure, i.e. both sides of the supporting substrate (110) are coated and both sides may be printed.

The coating layer (120) is disposed on the supporting base substrate (110) and forms a coating layer having a coat-weight in the range of about 1 to about 30 gram per square meter (g/m² or gsm) per side, or in the range of about 5 to about 20 gsm, or in the range of about 8 to about 15 gsm per side. In some examples, the printable recording media contains a coating layer (120) that is applied to only one side of the supporting base substrate (110) and that has a coat-weight in the range of about 1 to about 30 gsm. In some other examples, the printable recording media contains coating layers (120) that are applied to both sides of the supporting base substrate (110) and that that have a coat-weight in the range of about 10 to about 20 gsm per side.

The Base Substrate

As illustrated in FIG. 1, the printable media (100) contains a base substrate (110) that supports the coating layer(s) (120) and that acts as a bottom substrate layer. Such base print media substrate (i.e. substrate or base substrate or supporting substrate) contains a material that serves as a base upon which the coating layer is applied. The base substrate provides integrity for the resultant printable media. The amount of the coating layer, on the print media, in the dry state, is, at least, sufficient to hold all of the ink that is to be applied to the print media. The base substrate (110) can have a thickness along substantially the entire length ranging between about 0.025 mm and about 0.5 mm.

The base substrate may include any materials which can support a coating composition, for example, natural materials (such as a base including cellulose fibers) or synthetic material, (such as a base including synthetic polymeric fibers) or non-fabric materials (such as a polymeric film) or a mixture of them. The base substrate material has good affinity and good compatibility for the ink that is applied to the material.

Examples of substrates include, but are not limited to, natural cellulosic material, synthetic cellulosic material (such as, for example, cellulose diacetate, cellulose triacetate, cellulose propionate, cellulose butyrate, cellulose acetate butyrate and nitrocellulose), material including one or more polymers such as, for example, polyolefins, polyesters, polyamides, ethylene copolymers, polycarbonates, polyurethanes, polyalkylene oxides, polyester amides, polyethylene terephthalate, polyethylene, polystyrene, polypropylene, polycarbonate, polyvinyl acetal, polyalkyloxazolines, polyphenyl oxazolines, polyethylene-imines, polyvinyl pyrrolidones, and combinations of two or more of the above. In some examples, the media substrate includes a paper base including paper, cardboard, paperboard, paper laminated with plastics, and paper coated with resin. The base substrate may include polymeric binders. Such polymeric binder may be included, for example, when non-cellulose fibers are used. The base substrate may include cellulose fibers and synthetic fibers. The cellulose fibers may be made from hardwood or softwood species. The fibers of the substrate material may be produced from chemical pulp, mechanical pulp, thermal mechanical pulp, chemical mechanical pulp or chemical thermo-mechanical pulp. Examples of wood pulps include, but are not limited to, Kraft pulps and sulfite pulps, each of which may or may not be bleached. Examples of softwoods include, but are not limited to, pine, spruce and hemlock. Examples of hardwoods include, but are not limited to, birch, maple, oak, poplar and aspen. The synthetic fibers may be made from polymerization of organic monomers. The base substrate may also include non-cellulose fibers.

The basis weight of the print media substrate is dependent on the nature of the application of the print media where lighter weights are employed for magazines, books and tri-folds brochures and heavier weights are employed for post cards and packaging applications, for example. The substrate can have a basis weight of about 60 grams per square meter (g/m² or gsm) to about 400 gsm, or about 100 gsm to about 250 gsm.

The Coating Layer

The printable media contains a coating layer (120) disposed onto the base substrate (110). In some example, the coating layer (120) is present on, at least, one side of the base substrate (110). In some other examples, the coating layer (120) is present on both side of the base substrate (110). The coating layer (120) includes a coating formula with at least three different kinds of inorganic pigment, including a first pigment of precipitated calcium carbonate (PCC), a second inorganic pigment with different average particle size and morphology than the first pigment, and a third inorganic pigment with a surface-area of at least 50 m²/g.

Such coating layer (120) encompasses: from about 10 to about 90 wt % of a first pigment including precipitated calcium carbonate particles; from about 5 to about 60 wt % of a second pigment having a larger size and a different shape than the first pigment particles; and from about 1 to about 50 wt % of a third pigment comprising particles of a liquid absorptive high surface area material having a surface area of at least 50 m²/gram, wherein the weight percentages are by combined weight of the first, second and third pigments by total dry weight of the coating layer.

In some examples, the first pigment, present in the coating layer (120), is precipitated calcium carbonate (PCC) particles with narrow size-distribution. Such precipitated calcium carbonate (PCC) particles can have an average particle size of less than 1 micron, or less than about 400 nm or even smaller. PCC particles, in the specified size ranges, may be prepared in accordance with methods that are described in the literature, such as, for example, in the Chapter 2, of “The Coating Processes” (edited by J. C. Walter, Tappi Press, Atlanta, Ga., 1993). The first pigment can be, for examples, Opacarb® A40 (from BASF). In some examples, the first pigment, of the coating layer, is present in an amount representing from about 10 to about 90 wt %; or, in some other examples, in an amount representing from about 25 to about 75 wt %; or, in yet some other examples, in an amount representing from about 30 to about 65 wt % of the total dry weight of the coating layer.

The second pigment that is present in the coating layer (120) has different shape and particle size, compared to the PCC particles. Without wishing to be limited to any theory, it is believed that inclusion of the second pigment disrupts the packing structure of PCC particles in coating layer, creating voids between particles that enhance the flow and storage of liquid. The second pigment can be a ground calcium carbonate (GCC) pigment, or clay pigment such as kaolin clay, hydrated clay, calcined clay, or other material that is capable of functioning in a similar manner. In some other examples, the second pigment of the coating layer is a combination of ground calcium carbonate particles and platey clay particles.

The second pigment can have a larger particle size and a different shape than the PCC pigment. The average particle size of the second pigment can be in the range of about 0.5 to about 10 μm. In certain instances, the second pigment's size is in the range of about 0.5 to about 5 μm, and, in some cases, in the range of about 0.8 to about 2 μm in size. Ground calcium carbonate (GCC) and platey clay particles, in the specified size ranges, may be prepared in accordance with methods that are, for example, as described in Chapter 2, in “The Coating Processes” (edited by J. C. Walter, Tappi Press, Atlanta, Ga., 1993).

In some examples, the second pigment, present in the coating layer (120), is a clay pigment, especially a clay pigment with a high aspect ratio, sometimes referred to as “platey clay.” Platey clays have a planar shape, with dimensions ranging from submicron up to several microns (μm), or even up to more than 10 microns (μm). In some other examples, the second pigment is calcined clay. In yet some other examples, the second pigment is a combination of ground calcium carbonate (GCC) particles and platey clay. The weight ratio between GCC particles and platey clay can be in the range of from 1:5 to 5:1.

The second pigment is present, in the coating layer (120), in an amount representing from about 5 to about 60 wt %; or, in some other examples, in an amount representing from about 10 to about 50 wt %; or, in yet some other examples, in an amount representing from about 20 to about 40 wt% based on the total dry weight of the coating layer.

The coating layer (120) includes third pigment particles having a surface area of at least 50 m²/gram. Said third pigment particles include particles of a liquid absorptive high surface area material having a surface area of at least 50 m²/gram.

In some examples, the third pigment has a higher surface area than the first and second pigments. Suitable materials for the third pigment particles include, but are not limited to, fumed silica, silica gel, colloidal silica, zeolite, and alumina, although any another suitable material capable of functioning similarly to those materials could be used. For example, materials with nano-meter scale structure, such as the engineered calcium carbonate Omyajet® (Omya Corporation, Alpharetta, Ga.) may serve as the third pigment in some instances. Omyajet® is a specialty ground calcium carbonate pigment. Its surface has been through special treatment to increase surface area and liquid absorption rate, to a high BET surface area of about 50 m²/g. In some examples, the third pigment is present, in the coating layer, in an amount representing from about 1 to about 50 wt % of the total dry weight of the coating layer; in some other examples, in an amount representing from about 5 to about 40 wt %; or, in yet some other example, in an amount representing from about 10 to about 25 wt % of the total dry weight of the coating layer. In some examples, the third pigment is a silica pigment. Silica pigment includes but is not limited to fumed silica, silica gel, colloidal silica, or precipitated silica. In the coating formula, silica pigment could be from a single source in a powder form or in a slurry form, or a mixture of any two or more different kinds of silica particles in powder or slurry form. Silica can be used as a third pigment, in order, for examples, to improve rub resistance and reduces high-lighter smear of printed sheets.

A combination of a particle size and a coat-weight of the coating layer, on the printable recording media, yields to pore size distribution in the range of about 0.025 microns (μm) to about 1.0 microns (μm). In some examples, the pore size distribution is in the range of about 0.05 microns (μm) to about 0.5 microns (μm). In some other examples, the pore size distribution is in the range of about 0.08 microns (μm) to about 0.3 microns (μm). The phrase “pore size” refers to the pores that are formed by a particulate inorganic pigment associated with a print media substrate. The pores are formed by a combination of an average particle size of the particulate inorganic pigment, a particle size distribution of the particulate inorganic pigment and a coat-weight of the particulate inorganic pigment. “Particle size distribution” refers to the percentage of particles falling within a particular size range. For purposes of illustration and not limitation, an example is a particle size distribution where about 75% to about 85% of the particles have a particle size in a range of about 1.0 to about 1.4 microns (μm).

The coating layer (120) includes an acrylic resin latex binder. Such acrylic latex polymer may be derived from a number of acrylic monomers and might contain others monomer such as, by way of example and not limitation, vinyl monomers, allylic monomers, olefins, and unsaturated hydrocarbons, and mixtures thereof. Classes of vinyl monomers include, but are not limited to, vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, and mixtures of two or more of the above, for example.

In some examples, the acrylic resin latex binder is a styrene acrylic latex binder. Such acrylic resin latex binder can be available, for examples, under the tradename Joncryl® 82 available from BASF. In some other examples, the acrylic resin latex binder is an acrylate acrylic polymeric composition containing styrene units which is resistant to various solvents including methanol, 3A ethanol, isopropanol, n-propanol, ethylene glycol monobutyl ether, diethylene glycol monoethyl ether, acetone, methylene ketone and methyl isobutyl ketone. The acrylic resin latex binder is present, in the coating layer, in an amount representing from about 2 wt % to about 20 wt %, or representing from about 4% to about 10%, by total dry weight of the coating layer.

The coating composition, as described herein, might further contain a water-soluble polyvinyl alcohol (PVA) binder. In some examples, the water-soluble polyvinyl alcohol (PVA) binder is present in an amount representing from about 0.01 wt % to about 8 wt % by total dry weight of the coating layer. In some other examples, the water-soluble polyvinyl alcohol (PVA) binder is present in an amount representing from about 0.1% to about 3%, by total dry weight of the coating layer. The polyvinyl alcohol (PVA) may have a relatively low molecular weight with a relatively medium hydrolysis. The polyvinyl alcohol (PVA) may also have a relatively high molecular weight with a relatively high hydrolysis. Non-limiting examples of a polyvinyl alcohol (PVA) may comprise PVA BF-5 available from Chang Chun Petrochemical Co., Ltd. and Mowiol® 15-99 or Mowiol® 4-98 available from Kuraray America, Inc.

In addition to the above-described pigments and binders, the coating layer formulations might also contain other components or additives, as necessary, to carry out the required mixing, coating, manufacturing, and other process steps, as well as to satisfy other requirements of the finished product, depending on its intended use. The additives include, but are not limited to, one or more of rheology modifiers, thickening agents, cross-linking agents, surfactants, defoamers, optical brighteners, dyes, pH controlling agents or wetting agents, and dispersing agents, for example. The total amount of additives, in the composition for forming the coating layer, can be from about 0.1 wt % to about 5 wt % or from about 0.2 wt % to about 3 wt %, by total dry weight of the coating layer.

Method for Making the Printable Recording Material

In some examples, according to the principles described herein, a method of making a printable recording media comprising a supporting base substrate (110) and a coating layer (120) is provided. Such method encompasses: providing a base substrate (110); applying a coating layer (120) that contains an acrylic resin latex binder and a mixture of about 10 to about 90 wt % of a first pigment including precipitated calcium carbonate particles, about 5 to about 60 wt % of a second pigment having a larger size and a different shape than the first pigment particles, and about 1 to about 50 wt % of a third pigment having a surface area of at least 50 m²/gram, wherein said weight percentages are by combined weight of the first, second and third pigments by total dry weight of said coating layer, and drying and calendaring said coating layer.

In some examples, the coating layer (120) is applied to the base substrate (110) on the image receiving side of the printable media. In some other examples, the coating layer (120) is applied to the supporting base substrate (110) on the image receiving side and on the backside of the printable media.

The coating layer (120) can be applied to the base substrate (110) by using one of a variety of suitable coating methods, for example blade coating, air knife coating, metering rod coating, size press, curtain coating, or another suitable technique. In some examples, the coating layers can be applied in one single production run. When the coating layer are present on both sides of the base substrates, depending on set-up of production machine in a mill, both sides of the substrate may be coated during a single manufacture pass, or each side is coated in a separate pass.

In some examples, after the coating step, the media might go through a drying process to remove water and other volatile components present in the coating layers and substrate. The drying pass may comprise several different drying zones, including, but not limited to, infrared (IR) dryers, hot surface rolls, and hot air floatation boxes. In some other examples, after the coating step, the coated web may receive a glossy or satin surface with a calendering or super calendering step. When a calendering step is desired, the coated product passes an on-line or off-line calender machine, which could be a soft-nip calender or a super-calender. The rolls, in the calender machine, may or may not be heated, and certain pressure can be applied to calendering rolls. In addition, the coated product may go through embosser or other mechanical roller devices to modify surface characteristics such as texture, smoothness, gloss, etc.

In some examples, the coating layer is associated with the print media. The phrase “associated with” means that a layer is, for example, formed on, coated on, adsorbed on or absorbed in at least one surface of the print media substrate. The association between a layer and a surface of the print media substrate is achieved by bringing the substrate and composition forming the layer into contact by, for example, spraying, dipping and coating (including, e.g., roll, blade, rod, slot die, or curtain coating).

When the base substrate is base paper stock, the composition for forming the coating layer can be applied on the base paper stock by an in-line surface size press process such as a puddle-sized press or a film-sized press, for example. In addition to in-line surface sizing processing, off-line coating technologies can also be used to apply the composition for forming the coating layer to the print media substrate. Examples of suitable coating techniques include, but are not limited to, slot die coaters, roller coaters, fountain curtain coaters, blade coaters, rod coaters, air knife coaters, gravure applications, and air brush applications, for example.

Method for Producing Printed Images

The method for producing printed images, or printing method, includes providing a printable recording media such as defined herein; applying an ink composition on the coating layer of the print media, to form a printed image; and drying the printed image in order to provide, for example, a printed image with enhanced quality and enhanced image permanence. The printable recording media contains a base substrate and a coating layer including an acrylic resin latex binder; and a mixture of: about 10 to about 90 wt % of a first pigment including precipitated calcium carbonate particles, about 5 to about 60 wt % of a second pigment having a larger size and a different shape than the first pigment particles, and about 1 to about 50 wt % of a third pigment having a surface area of at least 50 m²/gram, wherein the weight percentages are by combined weight of the first, second and third pigments by total dry weight of the coating layer.

In some examples, the printing method for producing images is an inkjet printing method. By inkjet printing method, it is meant herein a method wherein a stream of droplets of ink is jetted onto the recording substrate or media to form the desired printed image. The ink composition may be established on the recording media via any suitable inkjet printing technique. Examples of inkjet method include methods such as a charge control method that uses electrostatic attraction to eject ink, a drop-on-demand method which uses vibration pressure of a Piezo element, an acoustic inkjet method in which an electric signal is transformed into an acoustic beam and a thermal inkjet method that uses pressure caused by bubbles formed by heating ink. Non-limitative examples of such inkjet printing techniques include thus thermal, acoustic and piezoelectric inkjet printing. In some examples, the ink composition is applied onto the recording media using inkjet nozzles. In some other examples, the ink composition is applied onto the recording method using thermal inkjet printheads.

In some examples, the printing method is a capable of printing more than about 50 feet per minute (fpm) (i.e. has a print speed that is more than about 50 fpm). The printing method described herein can be thus considered as a high-speed printing method. The web-speed could be from about 100 to about 4 000 feet per minute (fpm). In some other examples, the printing method is a printing method capable of printing from about 100 to about 1 000 feet per minute. In yet some other examples, the printing method is capable of printing at a web-speed of more than about 200 feet per minute (fpm).

In some example, the printing method is a high-speed web press printing method. As “web press”, it is meant herein that the printing technology encompasses an array of inkjet nozzles that span the width of the paper web. The array is thus able, for example, to print on 20″, 30″, and 42″ wide web or on rolled papers.

In some examples, the printing method as described herein prints on one-pass only. The paper passes under each nozzle and printhead only one time as opposed to scanning type printers where the printheads move over the same area of paper multiple times and only a fraction of total ink is used during each pass. The one-pass printing puts 100% of the ink from each nozzle/printhead down all at once and is therefore more demanding on the ability of the paper to handle all of the ink in a very short amount of time.

As mentioned above, a print media in accordance with the principles described herein may be employed to print images on one or more surfaces of the print media. In some examples, the method of printing an image includes depositing ink that contains particulate colorants. A temperature of the print media during the printing process is dependent on one or more of the nature of the printer, for example. Any suitable printer may be employed such as, but not limited to, offset printers and inkjet printers. In some examples, the printer is a HP T350 Color Inkjet Webpress printer (Hewlett Packard Inc.). The printed image may be dried after printing. The drying stage may be conducted, by way of illustration and not limitation, by hot air, electrical heater or light irradiation (e.g., IR lamps), or a combination of such drying methods. In order to achieve best performances, it is advisable to dry the ink at a maximum temperature allowable by the print media that enables good image quality without deformation. Examples of a temperature during drying are, for examples, from about 60° C. to about 205° C., or from about 120° C. to about 180° C. The printing method may further include a drying process in which the solvent (such as water), that can be present in the ink composition, is removed by drying. As a further step, the printable recording media can be submitted to a hot air drying systems. The printing method can also encompass the use of a fixing agent that will retain with the pigment, present in the ink composition that has been jetted onto the media.

### EXAMPLES

### Ingredients:

TABLE 1

| Ingredient name | Nature of the ingredient | supplier |
|---|---|---|
| Opacarb ®A40 | precipitated calcium carbonate | BASF |
| | pigment (average particle size | |
| | of 0.4 μm) | |
| Hydrocarb ®60 | ground calcium carbonate | Omya |
| | (average particle size of | |
| | 1.5 μm) | |
| Kaocal ® | calcined clay | Thiele Kaolin |
| | | Company |
| Sylojet ®A25 | silica dispersion | Grace Davison |
| Mowiol ®4-98 | water-soluble polymer-polyvinyl | Sigma-Aldrich |
| | alcohol | |
| Joncryl ®82 | styrene acrylic latex binder | BASF |
| Gencryl ®PT9525 | styrene butadiene water- | Omnova |
| | dispersible latex binder | |
| Rovene ®4040 | styrene butadiene latex binder | Mallard Creek |
| | | Polymers |
| Sancure ®2026 | urethane latex binder | Lubrizol |
| AU 4010 | polyurethane acrylic hybrid | Lubrizol |
| | dispersion | |

### Example 1

### Coating Layer Formulations

The coating layer formulations 1 to 5 are expressed in Table 2 below (formulations 2 to 5 are comparative examples). Each number represents the parts of each component, present in each layer, based on 100 parts of inorganic pigments and based on the amount of dry chemicals.

TABLE 2

| | | | Comparative | Comparative | Comparative | Comparative |
|---|---|---|---|---|---|---|
| Coating ingredients | | Coating 1 | Coating 2 | Coating 3 | Coating 4 | Coating 5 |
| Pigments | Hydrocarb ®60 | 30 | 30 | 30 | 30 | 30 |
| | Opacarb ®A40 | 10 | 10 | 10 | 10 | 10 |
| | Kaocal ® | 50 | 50 | 50 | 50 | 50 |
| | Sylojet ®A-25 | 10 | 10 | 10 | 10 | 10 |
| PVOH | Mowiol ®4-98 | 0.5 | 0.5 | 0.5 | 0.5 | 0.5 |
| Latex | Joncryl ®82 | 9 | — | — | — | — |
| | Gencryl ®9525 | — | 9 | — | — | — |
| | Rovene ®4040 | — | — | 9 | — | — |
| | Sancure ®2026 | — | — | — | 9 | — |
| | AU 4010 | — | — | — | — | 9 |
| Defoamer | | 0.2 | 0.2 | 0.2 | 0.2 | 0.2 |

### Example 2

### Printable Recording Media

In the coating layer formulations 1 to 5, chemicals are mixed together in a tank by using normal stirring equipment. Such compositions 1 to 5 are applied to both surfaces of a raw base paper at a coat weight of 15 gsm using a Meyer rod in view of obtaining media samples I to V, wherein media I is a media according to the present disclosure and wherein media II, III, IV and V are comparative media samples. The recording media are then calendered through a super calendar machine (at 2000 psi at room temperature). The media samples I to V are then printed using a high-speed inkjet printer HP Edgeline Printer CM8060 MFP (using pigmented ink composition). The prints were made in 2 pass/6 dry spin mode.

Resistance tests are performed onto the obtained printed media. The printed media sample are tested for durability immediately after printing (t=0 H) and at 24 hours after printing (t=24 H), the media are tested for “dry rub resistance” and “fingerprinting resistance”

The “dry rub resistance” test refers to the ability of a printed image to resist appearance degradation upon rubbing the image with dry finger. Good dry rub resistance, upon rubbing, will tend to not transfer ink from a printed image to surrounding areas where the ink has not been printed. In the “Finger Smudge” test (on Black and Red), a finger is placed on the print with sufficient force to bend at the knuckle and drawn down. In the “Eraser” test (on Black and Red), a pencil eraser is mounted on a force spring to provide a consistent and reproducible pressure. The eraser is pressed against the print and drawn down 3 times. In the Paper-to-Print test (on Black and Red), a portion of unprinted coated paper is rubbed against a portion of printed paper.

The “Fingerprint resistance” test refers to the ability of a printed image to resist appearance degradation upon user handling of the media. In the “Fingerprint test”, a dry finger is pressed against the print and lifted off. In the “Wet-Fingerprint test”, a fingertip is dipped in water, the excess water is removed and then the fingertip is placed against the print and lifted off.

Each durability testing item is then given a rating score according to a 1 to 5 scale, as described in the Table 3 below, wherein 1 means the worst performance (all the ink in the image has been removed), and 5 represents the best performance (the image shows no damage).

TABLE 3

| Score Value | Meaning |
|---|---|
| 5 | No Damage |
| 4 | Very slight damage |
| 3 | Some of ink gone |
| 2 | >50% of ink removed |
| 1 | See white paper, ink total damage or transfer |

The durability results, after printing (t=0 H) and at 24 hours after printing (t=24 H), are reported in Table 4 and Table 5. Dry Rub Scores (*) and the Fingerprint Scores (*) illustrate the durability scores of each sample and can be interpreted as an overall durability performance score. According to such results, it can be seen that the media with the coating composition of the present disclosure provides the best overall scores on durability.

TABLE 4

| | | | | | | | |
|---|---|---|---|---|---|---|---|
| | Black | Red | | | Black | Red | |
| | finger | Finger | Black | Red | Paper-to- | Paper-to- | Dry rub |
| Media Samples | Smudge | Smudge | Eraser | Eraser | Print | Print | score* |

Dry Rub tests at t = 0

| | | | | | | | |
|---|---|---|---|---|---|---|---|
| Example I | 4 | 3 | 3.5 | 3 | 4.5 | 3.5 | 3.6 |
| Comp. II | 3 | 2.5 | 3 | 2.5 | 3.5 | 2.5 | 2.8 |
| Comp. III | 3 | 2 | 2.5 | 2 | 3 | 2.5 | 2.5 |
| Comp. IV | 3.5 | 2.5 | 3.5 | 3 | 4 | 3 | 3.3 |
| Comp. V | 3.5 | 2.5 | 3 | 2.5 | 4 | 3 | 3.1 |

Dry Rub tests at t = 24 h

| | | | | | | | |
|---|---|---|---|---|---|---|---|
| Example I | 4.5 | 3 | 4 | 4 | 4 | 3.5 | 3.8 |
| Comp. II | 4 | 2.5 | 3.5 | 3.5 | 3 | 2.5 | 3.2 |
| Comp. III | 4 | 2 | 3 | 2.5 | 3 | 3 | 2.9 |
| Comp. IV | 4.5 | 3 | 4 | 4 | 4 | 4 | 3.9 |
| Comp. V | 4 | 3 | 3 | 3.5 | 4 | 4 | 3.6 |

TABLE 5

| | | | | | |
|---|---|---|---|---|---|
| | Black | Red | Black Wet | Black Wet | Finger- |
| | Finger- | Finger- | Finger- | Finger- | print |
| Media Samples | print | print | print | print | score* |

Fingerprinting tests at t = 0

| | | | | | |
|---|---|---|---|---|---|
| Example I | 4 | 4.5 | 4.5 | 4.5 | 4.4 |
| Comp. II | 4 | 4 | 2 | 2.5 | 3.1 |
| Comp. III | 2.5 | 2.5 | 2 | 2.5 | 2.4 |
| Comp. IV | 4.5 | 4 | 2.5 | 3.5 | 3.6 |
| Comp. V | 3.5 | 3.5 | 3 | 2.5 | 3.1 |

Fingerprinting tests at t = 24 h

| | | | | | |
|---|---|---|---|---|---|
| Example I | 4.5 | 4.5 | 4 | 4.5 | 4.4 |
| Comp. II | 4.5 | 4 | 3 | 3.5 | 3.8 |
| Comp. III | 4 | 3 | 2.5 | 3 | 3.1 |
| Comp. IV | 4.5 | 4.5 | 4 | 4 | 4.3 |
| Comp. V | 3 | 4 | 4 | 3.5 | 3.9 |

1. A printable recording media comprising a base substrate and a coating layer including
a. an acrylic resin latex binder;
b. and a mixture of
i. about 10 to about 90 wt % of a first pigment including precipitated calcium carbonate particles,
ii. about 5 to about 60 wt % of a second pigment having a larger size and a different shape than the first pigment particles, and
iii. about 1 to about 50 wt % of a third pigment having a surface area of at least 50 m²/gram,
wherein said weight percentages are by combined weight of the first, second and third pigments by total dry weight of said coating layer.

2. The printable recording media of claim 1 wherein the acrylic resin latex binder is a styrene acrylic latex binder.

3. The printable recording media of claim 1 wherein the acrylic resin latex binder is present in an amount representing from about 2 wt % to about 20 wt % by total dry weight of the coating layer.

4. The printable recording media of claim 1 wherein the first pigment of the coating layer is present in an amount representing from about 25 to about 75 wt % of the total dry weight of said coating layer.

5. The printable recording media of claim 1 wherein the second pigment of the coating layer is a combination of ground calcium carbonate particles and platey clay particles.

6. The printable recording media of claim 1 wherein the third pigment of the coating layer is present in an amount representing from about 5 to about 40 wt % of the total dry weight of said coating layer.

7. The printable recording media of claim 1 wherein the third pigment of the coating layer is silica pigment.

8. The printable recording media of claim 1 wherein the coating layer further comprises a water-soluble polyvinyl alcohol binder.

9. The printable recording media of claim 8 wherein the water-soluble polyvinyl alcohol binder is present in an amount representing from about 0.01 wt % to about 5 wt % by total dry weight of the coating layer.

10. The printable recording media of claim 1 wherein the coating layer is applied to only one side of the base substrate and has a coat-weight in the range of about 1 to about 30 gsm.

11. The printable recording media of claim 1 wherein the coating layer is applied to both sides of the base substrate and have a coat-weight in the range of about 10 to about 20 gsm per side.

12. A method for producing printed images comprising:
a. obtaining a printable recording media containing a base substrate and a coating layer including an acrylic resin latex binder and a mixture of: about 10 to about 90 wt % of a first pigment including precipitated calcium carbonate particles, about 5 to about 60 wt % of a second pigment having a larger size and a different shape than said first pigment particles and about 1 to about 50 wt % of a third pigment having a surface area of at least 50 m²/gram, wherein said weight percentages are by combined weight of the first, second and third pigments by total dry weight of said coating layer;
b. applying an ink composition on the coating layer of said print media, to form a printed image; and
c. drying the printed image.

13. The method of claim 12 wherein the print speed is more than about 50 feet per minute.

14. The method of claim 12 wherein the ink composition is applied onto the printable recording media via inkjet nozzles.

15. A method for making a printable recording media comprising:
a. providing a base substrate;
b. applying a coating layer that contains an acrylic resin latex binder and a mixture of about 10 to about 90 wt % of a first pigment including precipitated calcium carbonate particles, about 5 to about 60 wt % of a second pigment having a larger size and a different shape than the first pigment particles, and about 1 to about 50 wt % of a third pigment having a surface area of at least 50 m²/gram, wherein said weight percentages are by combined weight of the first, second and third pigments by total dry weight of said coating layer;
c. and drying and calendaring said coating layer.
